(19) United States
(12) Patent Application Publication
(10) Pub. No.: US 2026/0092508 A1
(43) Pub. Date: Apr. 2, 2026

(54) HAZARDOUS WASTE CANISTER

(71) Applicant: Deep Isolation, Inc., Berkeley, CA (US)

(72) Inventors: Chris Parker, Bromley (GB); Jesse Sloane, Philadelphia, PA (US); Mark Frei, Arlington, VA (US); Steve Sisley, San Jose, CA (US)

(21) Appl. No.: 19/113,715

(22) PCT Filed: Oct. 3, 2023
(86) PCT No.: PCT/US2023/034389

§ 371 Date: Mar. 20, 2025

Related U.S. Application Data
(60) Provisional application No. 63/412,688, filed on Oct. 3, 2022.

(51) Int. Cl. E21B 41/00; G21F 5/008; G21F 5/12; G21F 9/36

(52) U.S. Cl. CPC E21B 41/005; G21F 5/008; G21F 5/12; G21F 9/36

(57) ABSTRACT

A hazardous waste canister includes a housing that defines an interior volume configured to store nuclear waste, the housing configured to enclose the nuclear waste in a human-unoccupiable drillhole formed from a terranean surface into a subterranean formation; a support assembly positioned within the inner volume and configured to fill at least a portion of a gap between the housing and the enclosed nuclear waste; a lid assembly configured to couple to an open end of the housing to seal the inner volume; and a lift assembly coupled to the lid assembly and configured to engage a lifting device.

### TECHNICAL FIELD

This disclosure relates to hazardous waste canisters and, more particularly, hazardous waste canisters that enclose radioactive waste and are suitable for emplacement in a human-unoccupiable drillhole.

### BACKGROUND

Hazardous waste is often placed in long-term, permanent, or semi-permanent storage so as to prevent health issues among a population living near the stored waste. Such hazardous waste storage is often challenging, for example, in terms of storage location identification and surety of containment. For instance, the safe storage of nuclear waste (e.g., spent nuclear fuel, whether from commercial power reactors, test reactors, or even military waste) is considered to be one of the outstanding challenges of energy technology. Safe storage of the long-lived radioactive waste is a major impediment to the adoption of nuclear power in the United States and around the world. Conventional waste storage methods have emphasized the use of tunnels and is exemplified by the design of the Yucca Mountain storage facility. Other techniques include boreholes, including vertical boreholes, drilled into crystalline basement rock. Other conventional techniques include forming a tunnel with boreholes emanating from the walls of the tunnel in shallow formations to allow human access.

### SUMMARY

In an example implementation, a hazardous waste canister includes a housing that defines an interior volume configured to store nuclear waste, the housing configured to enclose the nuclear waste in a human-unoccupiable drillhole formed from a terranean surface into a subterranean formation; a support assembly positioned within the inner volume and configured to fill at least a portion of a gap between the housing and the enclosed nuclear waste; a lid assembly configured to couple to an open end of the housing to seal the inner volume; and a lift assembly coupled to the lid assembly and configured to engage a lifting device.

In an aspect combinable with the example implementation, the nuclear waste includes spent nuclear fuel.

In another aspect combinable with one, some, or all of the previous aspects, the spent nuclear fuel includes a spent nuclear fuel assembly.

In another aspect combinable with one, some, or all of the previous aspects, the spent nuclear fuel assembly includes a single spent nuclear fuel assembly.

In another aspect combinable with one, some, or all of the previous aspects, the spent nuclear fuel assembly includes a PWR fuel assembly.

In another aspect combinable with one, some, or all of the previous aspects, the support assembly includes a fuel tube configured to surround the spent nuclear fuel assembly in the gap.

In another aspect combinable with one, some, or all of the previous aspects, the support assembly includes at least one side insert configured for insertion in the gap between the fuel tube and the housing.

In another aspect combinable with one, some, or all of the previous aspects, the at least one side insert includes at least four side inserts configured for insertion in the gap between the fuel tube and the housing.

In another aspect combinable with one, some, or all of the previous aspects, rein the housing includes a side assembly and a base assembly coupled to the side assembly.

In another aspect combinable with one, some, or all of the previous aspects, the base assembly is welded to the side assembly.

In another aspect combinable with one, some, or all of the previous aspects, the base assembly and the lid assembly include a gamma shielding.

In another aspect combinable with one, some, or all of the previous aspects, the side assembly excludes the gamma shielding.

In another aspect combinable with one, some, or all of the previous aspects, the lift assembly is configured to couple to a downhole conveyance.

In another aspect combinable with one, some, or all of the previous aspects, the downhole conveyance includes a wireline or a downhole tractor.

In another aspect combinable with one, some, or all of the previous aspects, the housing is included of a steel alloy.

In another aspect combinable with one, some, or all of the previous aspects, the steel alloy includes Duplex stainless steel.

In another aspect combinable with one, some, or all of the previous aspects, the lift assembly is configured to attach to the housing with one or more bolts.

Another aspect combinable with one, some, or all of the previous aspects further includes a closure ring configured to seal the inner volume when the lid assembly is coupled to the housing.

In another aspect combinable with one, some, or all of the previous aspects, the closure ring is positioned between at least a portion of the lid assembly and the housing.

In another aspect combinable with one, some, or all of the previous aspects, the housing is cylindrical.

In another aspect combinable with one, some, or all of the previous aspects, the support assembly is configured to transfer heat from the enclosed nuclear waste to the housing.

In another aspect combinable with one, some, or all of the previous aspects, the nuclear waste has a heat load of 1.21 kW.

In another aspect combinable with one, some, or all of the previous aspects, the housing has a cylindrical cross-section and the nuclear waste includes a spent nuclear fuel assembly having a square cross-section, and the support assembly is configured to fill the gap between the housing and the spent nuclear fuel assembly.

In another aspect combinable with one, some, or all of the previous aspects, the spent nuclear fuel assembly has a 17″ by 17″ square cross-section.

In another aspect combinable with one, some, or all of the previous aspects, the spent nuclear fuel assembly is a PWR spent nuclear fuel assembly.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic illustration of an example implementation of a hazardous waste repository formed in a drillhole to store hazardous waste in one or more hazardous waste canisters according to the present disclosure.

FIG. 2A is a schematic illustration of a cross-section of an example implementation of a hazardous waste canister according to the present disclosure.

FIG. 2B is a schematic illustration of an isometric view of a portion of an example implementation of a hazardous waste canister according to the present disclosure.

### DETAILED DESCRIPTION

The present disclosure describes example implementations of apparatus, systems, and methods for the storing (permanently or temporarily) of hazardous waste (such as nuclear waste) that is emplaced in a hazardous waste repository formed in a deep, directional (or vertical or slanted) drillhole within a subterranean formation. Such example implementations of apparatus, systems, and methods include hazardous waste canisters that enclose and seal within hazardous waste, which can include spent nuclear fuel, high level waste, TRansUranic waste, and other forms of nuclear waste.

Implementations according to the present disclosure utilize the example hazardous waste canister to emplace hazardous waste in drillholes (e.g., wellbores or boreholes) using vertical, slant, directional, or other drilling techniques far deeper underground than in a mined repository (such as Yucca Mountain). Geologic media such as sedimentary, igneous, or metamorphic host rocks that have remained isolated from the environment for hundreds of thousands to millions of years can be a preferred location for such borehole disposal.

Example implementations of a hazardous waste canister (e.g., in combination with human-unoccupiable drillhole emplacement) according to the present disclosure can provide for a more economical disposal solution for spent fuel and high level waste from existing reactors, advanced reactors, small modular reactors and for countries with smaller waste inventories, since borehole disposal can also be modular. Such example implementations can be more effective by facilitating the packaging of that waste—for example a spent nuclear fuel assembly or portion thereof when removed from a spent fuel pool—directly into a “disposal ready” canister (versus putting it into standard dry cask) that is designed to fit into a drillhole. Furthermore, a standardized canister designed for borehole disposal presents provides for greater system efficiencies throughout the nuclear power life cycle, while preserving options for other disposal methods such as mined geologic repositories.

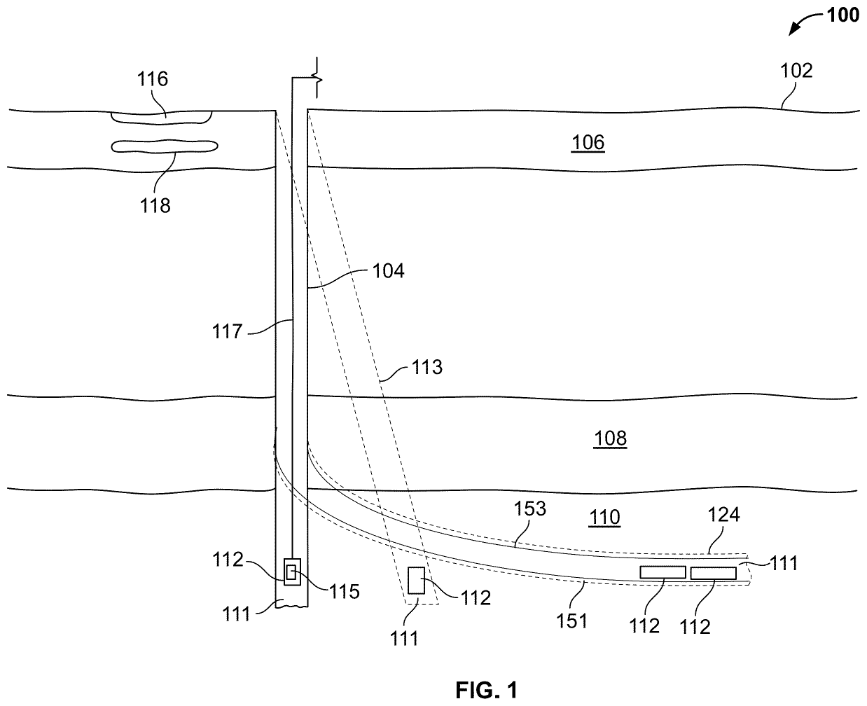

FIG. 1 is a schematic illustration of an example implementation of a hazardous waste repository 100 formed in a drillhole to store hazardous waste in one or more hazardous waste canisters according to the present disclosure. As shown in this example, one or more human-unoccupiable wellbores 104 (e.g., drillholes or boreholes) can be formed (e.g., drilled) from the Earth's surface 102 into a subterranean formation 110 that is suitable for the storage (temporary or permanent) of hazardous waste (e.g., chemical waste, biological waste, radioactive waste, etc.) in one or more hazardous waste canisters 112. In some aspects, the wellbores 104 are only vertical (or substantially vertical taking into account slight offsets due to the drilling process). As shown in FIG. 1, the wellbore 104 can be vertical, tilted (such as slant wellbore 113), or have a gradually changing direction (such as horizontal portion 124 coupled to wellbore 104 through a curved portion).

In some aspects, the wellbores 104 include non-vertical portions 124, such as curved or horizontal (or substantially horizontal) portions that are coupled to vertical portions that extend into the Earth, through subterranean formations 106 and 108, from the surface 102, and into the subterranean formation 110. In some aspects, one or more formations, such as a surface formation 106, may include surface water 116 or sub-surface, mobile water 118. One or more canisters 112 containing hazardous waste 115 is positioned (e.g., on a downhole conveyance 117 such as a wireline or other form of conveyance) in a storage portion 111 of the wellbores 104 that is located in the subterranean formation 110 (e.g., shale, salt, or other formation). In some aspects, all or a part of the wellbore 104 (such as a portion close to the surface 102) may be cased with a casing 153 that is secured with cement 151 (or other hardenable material). Hazardous waste can include radioactive waste, such as spent nuclear fuel, high level waste, TRansUranic (TRU) waste, or other forms of nuclear or radioactive waste.

As noted, the casing 153 can be installed with a layer of cement 151 circulated between it and the subterranean formation 110. In some aspects, the cement 151 can be chosen to be strongly corrosion resistant and to isolate the casing 153 from rock brine. The liquid that pushes the cement 151 into the gap between the casing 153 and the subterranean formation 110 can contain corrosion-inhibitors to reduce corrosion in cracks and crevices in the cement 151.

In example implementations, hazardous waste canisters 112 can be attached or coupled with the downhole conveyance 117 (e.g., tubular workstring, coiled tubing, wireline, or otherwise). Alternative implementations can also include emplacement of the canisters 112 into the storage region 111 with a downhole wireline tractor.

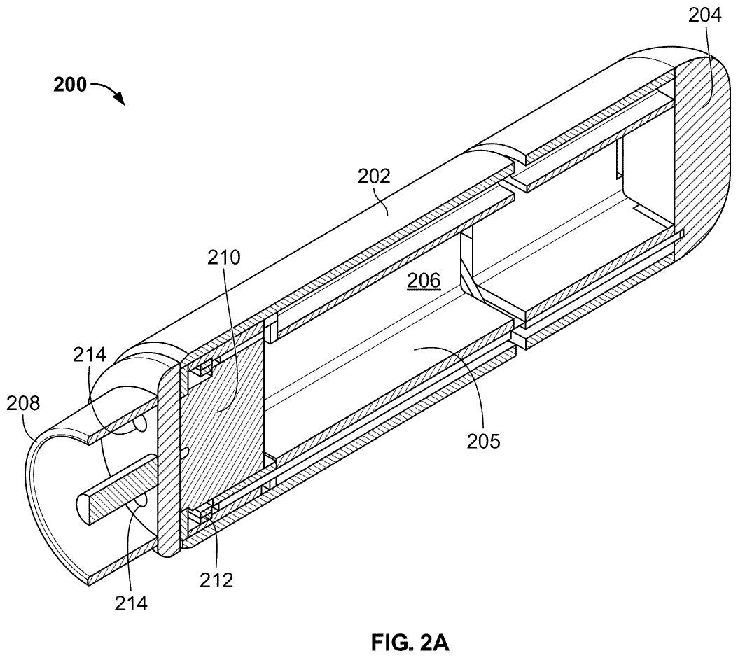

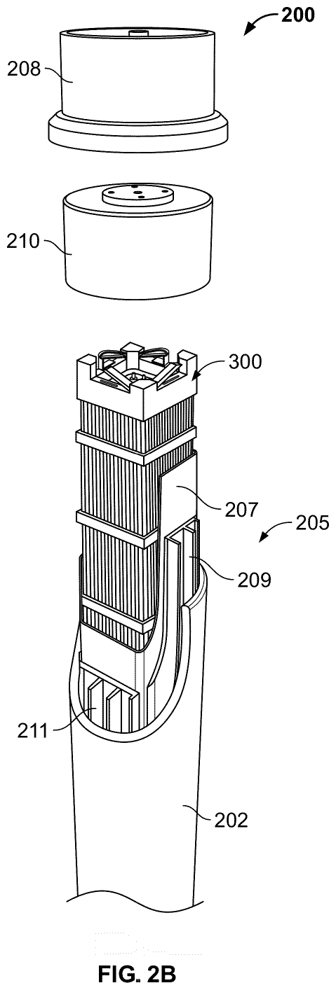

FIG. 2A is a schematic illustration of a cross-section of an example implementation of a hazardous waste canister 200 according to the present disclosure. FIG. 2B is a schematic illustration of an isometric view of a portion of the example implementation of the hazardous waste canister 200 with a cut away to show a spent nuclear fuel assembly 300 inserted therein. Hazardous waste canister 200 can be used as the canisters 112 shown in FIG. 1. As shown in this example, hazardous waste canister 200 includes a shell assembly 202 (or housing) that, along with a base assembly 204 and lid assembly 210, define an inner volume 206 sized to receive hazardous waste, such as, for example, one or more spent nuclear fuel assemblies. A support assembly 205 is positioned or coupled within the inner volume 206 to support any hazardous waste that is enclosed. In some aspects, the base assembly 204 is coupled to the shell assembly 202 with, for example, mechanical fasteners or welded; alternatively, the base assembly 204 can be formed integrally with the shell assembly 202.

In this example implementation of the hazardous waste canister 200, the canister 200 includes a closure ring 212 that seals hazardous waste enclosed in the inner volume 206 (e.g., gasses or other fluid that may come off solid waste) from reaching an exterior of the canister 200. Bolts 214 can secure a lift assembly 208 (and in some aspects the lid assembly 210) to the shell assembly 202. The lift assembly 208 allows the hazardous waste canister 200 to be transported by a lifting device (e.g., crane, rig, or otherwise), for example, from a transport cask or rig floor into a drillhole for emplacement.

The design of the hazardous waste canister 200 can eliminate a need for repackaging spent fuel for disposal, leaving open many nuclear waste management options for the lifecycle of the waste. Further, the hazardous waste canister 200 can be built to emplace in generic horizontal boreholes with vertical or nearly vertical access holes that gradually transition to, for example, a 1,500 to 3000-meter horizontal section in which the hazardous waste canisters 200 can be emplaced at total vertical depths ranging from 1,000 to 3,000 meters (for example in a subterranean formation 110).

A thickness of the shell assembly 202 (and other components) of the hazardous waste canister 200 can be specified depending on a depth of the storage region 111 in the drillhole to ensure structural integrity. In some aspects, the inner volume 206 is sized to accommodate a single intact PWR spent fuel assembly (such as a 17″×17″, square cross-section spent nuclear fuel assembly), while the inner volume 206 can also be sized to accommodate the majority (90% +) of PWR spent nuclear fuel assemblies generated in the United States and Europe.

The shell assembly 202 (as well as base and lid assemblies) can be fabricated with high-strength, corrosion-resistant steel alloy materials (such as Duplex stainless steel) to ensure integrity during emplacement as well as during any required near-term retrieval period. The hazardous waste canister 200 can be part of an overall engineered barrier system for storage, transport, and borehole disposal of radioactive waste. In this example, the shell assembly 202 is a cylindrical shell, and the base assembly 204 is an integral welded bottom plate. The lid assembly 210 can be field installed (e.g., at the site of the drillhole). The hazardous waste canister 200 includes drain and vent port features (not shown) that are used in wet-loading operations to drain water, vacuum dry, and backfill the inner volume 206 with a fluid or solid, such as an inert gas (such as helium). The lift assembly 208 is bolted to the top end of the shell assembly 202 to provide a lifting interface for handling at a borehole repository surface facility. The lift assembly 208 can be used only in the disposal configuration to assist with emplacement into (and if necessary for retrieval out of) the drillhole.

In some aspects, the internal support assembly 205 includes a fuel tube 207 and multiple side inserts 209 (or, a side insert per side of a fuel assembly) that bridge a gap 211 between the spent nuclear fuel assembly 300 and the shell assembly 202, providing both structural support and heat transfer capability required to meet current United States Nuclear Regulatory Commission (NRC) regulations. In some aspects, the hazardous waste canister 200 includes nuclear (e.g., gamma) shielding only at the ends (e.g., as part of the lid assembly 210 and the base assembly 204), to facilitate handling when placed, for example, in a shielded cask which would provide shielding around the shell assembly 202 of the canister 200.

Preliminary structural, thermal, shielding, and criticality safety evaluations were performed on an example embodiment of the hazardous waste canister 200 for design limiting conditions to develop canister designs sufficient to satisfy established regulatory requirements for storage and transportation and anticipated regulatory requirements for disposal. In particular, preliminary safety evaluations were performed for design-limiting conditions to develop canister designs sufficient to satisfy established and anticipated regulatory requirements, as follows:
Storage: United States Title 10 Code of Federal Regulations Part 72, “Licensing Requirements for the Independent Storage of Spent Nuclear Fuel, High-Level Radioactive Waste, and Reactor-Related Greater Than Class C Waste” and the equivalent International Atomic Energy Agency regulations.
Transportation: United States Title 10 Code of Federal Regulations Part 71, “Packaging and Transportation of Radioactive Material” and the equivalent International Atomic Energy Agency regulations.
Disposal: United States Title 10 Code of Federal Regulations Part 63, “Disposal of High-Level Radioactive Wastes in a Geologic Repository at Yucca Mountain, Nevada” and the equivalent International Atomic Energy Agency regulations.

The United States' disposal regulation, Title 10 Code of Federal Regulations Part 63, was established specifically for the proposed candidate repository site at Yucca Mountain, but it was used for this design effort as representing the most recent disposal regulatory framework from the United States NRC. The structural evaluation of the hazardous waste canister 200 included: (1) buckling analyses of the shell assembly 202 under repository (storage region 111) hydrostatic and lithostatic loading, (2) stress analyses of the hazardous waste canister 200 for repository handling conditions, including a vertical lift and retrieval of a stuck canister using the lift assembly 208 attached to the top of the canister 200, and (3) dynamic analyses of the canister 200 for a range of postulated drop events at the borehole repository, including free drops at a facility for loading hazardous waste into the canister 200 at a surface facility and free drops into, e.g., drillhole 124 from the terranean surface 102.

The buckling evaluation demonstrates that shell assembly 202 can withstand hydrostatic and lithostatic pressure loading in the drillhole and provides the required factors of safety against buckling instability. The repository handling evaluation demonstrates that the canister handling features satisfy the applicable allowable stress design criteria for normal handling conditions and off normal stuck canister retrieval conditions (e.g., conditions where the hazardous waste canister 200 is stuck in the drillhole 104, 113, and/or 124. For an inadvertent drop of the canister 200, evaluations were performed for a one-meter free drop onto an unyielding horizontal surface, a one-meter side drop onto a 6-inch diameter steel puncture bar, and a free drop into a 3.0-km deep brine-filled borehole; in the latter scenario, the analysis found that the canister 200 would stop prior to or soon after exiting, e.g., a curved section of directional drillhole 124 due to the hydrostatic resistance of fluid in the drillhole 124. Prior emplaced canisters 200 (e.g., prior to a drop) would be emplaced for enough into a horizontal section of the drillhole 124 to assure such a drop would not impact the canisters 200 already emplaced.

The thermal evaluation for transportation conditions, which is based on an array of canisters 200 emplaced in a MAGNATRAN® transportation cask equipped with a personnel barrier, each canister 200 having a heat load of 1.21 kW, demonstrated compliance with applicable temperature limits. The disposal thermal evaluation, which models an array of canisters 200, each with radiation and conduction heat transfer from the radioactive waste 15 (e.g., as fuel assemblies) to the canister 200, engineered barrier system and host rock at disposal depths ranging between 1 kilometer and 3 kilometers, demonstrated compliance with all applicable temperature limits.

The shielding evaluation was based on a single Westinghouse 17×17 PWR fuel assembly inside each canister 200 with representative source terms that are typical for fuel assemblies discharged in the last decade. For example, the following assumptions were used: 4.3 weight percent U-235 initial enrichment, 55 Gigawatt-days per metric ton uranium burnup, 7-year cool time in a spent fuel pool, and 1.21 kilowatt decay heat. The primary concern is the radiological dose above the canister during closure operations: a peak dose of 1.2 millisieverts per hour was calculated and this is sufficiently low to comply with occupational radiation exposure limits during canister loading operations. Surface dose rates were also calculated during transportation as well as for transfer cask operations; regulatory limits, including exclusive-use shipment limits, were met.

The criticality analysis demonstrated that no neutron absorbing materials were needed to comply with transportation criticality requirements. For disposal, it was found that an infinite array of parallel boreholes spaced 100-feet apart and containing canisters loaded with a PWR fuel assembly is inherently subcritical, even with fresh fuel and no neutron absorbers assumed in the canister 200.

In summary, the study of an example implementation of a hazardous waste canister 200 evaluated the canister for structural, thermal, shielding, and criticality aspects. The canister met all established regulatory requirements for storage and transportation and anticipated regulatory requirements for disposal. Importantly, this study provides a generic design that meets expected requirements for storage, transportation, and disposal while being small enough in diameter to facilitate disposal in a borehole.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

What is claimed is:

1. A hazardous waste canister, comprising:
a housing that defines an interior volume configured to store nuclear waste, the housing configured to enclose the nuclear waste in a human-unoccupiable drillhole formed from a terranean surface into a subterranean formation;
a support assembly positioned within the inner volume and configured to fill at least a portion of a gap between the housing and the enclosed nuclear waste;
a lid assembly configured to couple to an open end of the housing to seal the inner volume; and
a lift assembly coupled to the lid assembly and configured to engage a lifting device.

2. The hazardous waste canister of claim 1, wherein the nuclear waste comprises spent nuclear fuel.

3. The hazardous waste canister of claim 2, wherein the spent nuclear fuel comprises a spent nuclear fuel assembly.

4. The hazardous waste canister of claim 3, wherein the spent nuclear fuel assembly comprises a single spent nuclear fuel assembly.

5. The hazardous waste canister of claim 3, wherein the spent nuclear fuel assembly comprises a PWR fuel assembly.

6. The hazardous waste canister of claim 3, wherein the support assembly comprises a fuel tube configured to surround the spent nuclear fuel assembly in the gap.

7. The hazardous waste canister of claim 6, wherein the support assembly comprises at least one side insert configured for insertion in the gap between the fuel tube and the housing.

8. The hazardous waste canister of claim 7, wherein the at least one side insert comprises at least four side inserts configured for insertion in the gap between the fuel tube and the housing.

9. The hazardous waste canister of claim 1, wherein the housing comprises a side assembly and a base assembly coupled to the side assembly.

10. The hazardous waste canister of claim 9, wherein the base assembly is welded to the side assembly.

11. The hazardous waste canister of claim 9, wherein the base assembly and the lid assembly comprise a gamma shielding.

12. The hazardous waste canister of claim 11, wherein the side assembly excludes the gamma shielding.

13. The hazardous waste canister of claim 1, wherein the lift assembly is configured to couple to a downhole conveyance.

14. The hazardous waste canister of claim 13, wherein the downhole conveyance comprises a wireline or a downhole tractor.

15. The hazardous waste canister of claim 1, wherein the housing is comprised of a steel alloy.

16. The hazardous waste canister of claim 15, wherein the steel alloy comprises Duplex stainless steel.

17. The hazardous waste canister of claim 1, wherein the lift assembly is configured to attach to the housing with one or more bolts.

18. The hazardous waste canister of claim 1, further comprising a closure ring configured to seal the inner volume when the lid assembly is coupled to the housing.

19. The hazardous waste canister of claim 18, wherein the closure ring is positioned between at least a portion of the lid assembly and the housing.

20. The hazardous waste canister of claim 1, wherein the housing is cylindrical.

21. The hazardous waste canister of claim 1, wherein the support assembly is configured to transfer heat from the enclosed nuclear waste to the housing.

22. The hazardous waste canister of claim 1, wherein the nuclear waste has a heat load of 1.21 kW.

23. The hazardous waste canister of claim 1, wherein the housing has a cylindrical cross-section and the nuclear waste comprises a spent nuclear fuel assembly having a square cross-section, and the support assembly is configured to fill the gap between the housing and the spent nuclear fuel assembly.

24. The hazardous waste canister of claim 23, wherein the spent nuclear fuel assembly has a 17″ by 17″ square cross-section.

25. The hazardous waste canister of claim 24, wherein the spent nuclear fuel assembly is a PWR spent nuclear fuel assembly.
